(19) United States
(12) Patent Application Publication
(10) Pub. No.: US 2024/0177080 A1
(43) Pub. Date: May 30, 2024

(54) PROVIDING TRANSPORTATION MATCH PROBABILITY INDICATORS BASED ON VARIABLE DIRECTIONAL FILTERS IN A TRANSPORTATION MATCHING SYSTEM

(71) Applicant: Lyft, Inc., San Francisco, CA (US)

(72) Inventors: Martina Anne Pillay, Oakland, CA (US); Benjamin Jonas Plaut, Pittsburgh, PA (US); Heng Chen, San Francisco, CA (US); Guy-Baptiste Richard de Capele d'Hautpoul, San Francisco, CA (US); Owen Man-On Tong, San Francisco, CA (US); Andrew Jara Vorakrajangthiti, San Mateo, CA (US); John Chen, Toronto (CA)

(21) Appl. No.: 18/059,253

(22) Filed: Nov. 28, 2022

(51) Int. Cl. G06Q 10/0631; G06N 7/01

(52) U.S. Cl. CPC G06Q 10/06311; G06N 7/01

(57) ABSTRACT

The present disclosure relates to systems, non-transitory computer-readable media, and methods for, within a transportation matching system, identifying a threshold deviation angle or a threshold deviation radius, determining a directional filter, and providing a transportation match probability indicator based on the directional filter. In particular, in one or more embodiments, the disclosed systems provide a deviation angle control element or a dispatch radius control element for selectively designating the threshold deviation angle or the threshold deviation radius. In one or more embodiments, the disclosed systems update the transportation match probability indicator based on user manipulation of the deviation angle control element or the dispatch radius control element.

### BACKGROUND

In recent years, both popularity and usage of on-demand transportation information systems have increased. Indeed, the proliferation of web and mobile applications has enabled requesting devices to utilize on-demand transportation information systems to identify matches with provider devices and then coordinate across computing devices to initiate transportation from one geographic location to another. Despite these advances, conventional on-demand transportation information systems suffer from a number of technical drawbacks particularly in relation to capability, efficiency, and accuracy of implementing computer systems in determining digital matches and deploying provider devices.

For instance, conventional systems offer limited operational functionality for client devices with regard to control over computer-implemented directional algorithms. To illustrate, some conventional systems allow provider devices to select a destination, but provide limited functional control over the computer algorithms that determine transportation matches in navigating toward the selected destination. Indeed, some computer algorithms for determining provider device and requester device matches in moving a provider device toward a destination require fixed parameters to avoid undermining other matching algorithms or disrupting the balance between provider devices and requester devices within a geographical region. This lack of functionality undermines the flexibility of implementing computing systems and rigidly imposes particular parameters across provider devices. Further, conventional systems are unable to adjust to the context of particular provider devices in navigating provider devices toward a selected location.

Additionally, conventional systems are also inefficient. For example, conventional systems provide user interfaces to client devices that result in excessive time, interactions, and computer resources to operate. For example, due to the limited operational control in most conventional systems, provider devices often engage in multiple application and user interface interactions to navigate toward a destination location. For example, provider devices will repeatedly enter different destinations (to adjust transportation matches), cancel transportation matches that fall outside of preferred parameters (and then re-initiate a transportation matching algorithm), or provide user interactions to alternate between various modes (e.g., offline, online, and destination mode) due to the current interfaces used by conventional systems.

Moreover, conventional systems are also inaccurate. Indeed, conventional systems often generate inaccurate transportation matches that fail to align requester devices with available provider devices. For instance, conventional systems often match provider devices that need to navigate toward a particular destination with requester devices and transportation requests that do not accurately move the provider device toward the destination at a needed rate, speed, or efficiency. These inaccurate transportation matches lead to additional inefficiencies (e.g., cancellation requests, duplicate matching communications, loss of bandwidth) or device navigation to alternate applications or websites.

These along with additional problems and issues exist with regard to conventional on-demand transportation information systems.

### BRIEF SUMMARY

Embodiments of the present disclosure provide benefits and/or solve one or more of the foregoing or other problems in the art with systems, non-transitory computer-readable media, and methods for generating and providing provider device user interfaces that include deviation angle control elements and transportation match probability indications. In some embodiments, the disclosed systems provide a deviation angle control element, such as a slider bar, in tandem with a map display of a directional filter cone for filtering out transportation requests that would not bring a provider device closer to a target destination. The disclosed systems can receive user input dynamically modifying a width of the directional filter cone. Based on the width of the directional filter cone, the disclosed systems can determine a probability that the provider device will receive a transportation match along a route toward the target destination. The disclosed systems can display an indicator, such as a message, of the probability of a transportation match. Accordingly, the disclosed systems can provide efficient user interfaces that allows for improved computer functionality and flexibility in accurately identifying transportation matches and iteratively moving provider devices nearer to a selected target destination.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below. The drawings are not necessarily drawn to scale.

FIG. 1 illustrates a diagram of an environment in which a geotemporal destination system can operate in accordance with one or more embodiments.

FIG. 2 illustrates a diagram of a geotemporal destination system providing a deviation angle control element and a transportation match probability indicator in accordance with one or more embodiments.

FIG. 3 illustrates a schematic diagram of a directional filter of a geotemporal destination system in accordance with one or more embodiments.

FIG. 4 illustrates a diagram of a geotemporal destination system utilizing a prediction model in accordance with one or more embodiments.

FIGS. 5A-5B illustrate example user interfaces displaying a deviation angle control element and a transportation match probability indicator in accordance with one or more embodiments.

FIGS. 6A-6C illustrate example relationships between a threshold deviation angle and a destination progress threshold in accordance with one or more embodiments.

FIG. 7 illustrates a schematic diagram of a directional filter of a geotemporal destination system in accordance with one or more embodiments.

FIGS. 8A-8D illustrate example user interfaces displaying a deviation angle control element and a transportation match probability indicator in accordance with one or more embodiments.

FIG. 9 illustrates a schematic diagram of a radial match filter of a geotemporal destination system in accordance with one or more embodiments.

FIG. 10 illustrates a flowchart of a series of acts for providing a deviation angle control element and for providing a transportation match probability indicator in accordance with one or more embodiments.

FIG. 11 illustrates a block diagram of an example computing device for implementing one or more embodiments of the present disclosure.

FIG. 12 illustrates an example environment for a transportation matching system in accordance with one or more embodiments.

### DETAILED DESCRIPTION

This disclosure describes one or more embodiments of a geotemporal destination system that generates and provides a user interface comprising a deviation angle control element and a transportation match probability indicator for intelligently generating and applying directional filters for geotemporal destination transportation matching. In particular, the geotemporal destination system can apply a directional filter to identify transportation requests associated with a transportation matching system to surface one or more transportation requests to a provider device while the provider device travels toward a target destination. For example, the geotemporal destination system can identify transportation requests that are within a threshold deviation angle of a direction from a provider device location to a target destination. Moreover, the geotemporal destination system can identify transportation requests that satisfy an arrival time filter based on a target arrival time that the provider device sets for the target destination. The geotemporal destination system can filter out (e.g., reduce or eliminate) transportation requests that do not satisfy the directional filter and/or the arrival time filter. The geotemporal destination system can allow a provider device to selectively change settings associated with the directional filter. For example, the geotemporal destination system provides a deviation angle control element, whereby the provider may select (e.g., change) a threshold deviation angle. The geotemporal destination system can predict a transportation match probability associated with the directional filter, based on the user-selected threshold deviation angle.

To illustrate, the geotemporal destination system displays a map of a transportation area on a provider device, along with indicators of the provider device location and the target destination. The geotemporal destination system draws a cone on the map originating from the provider device location and directed generally toward the target destination. The geotemporal destination system provides a control element (e.g., a slider bar) for the provider to modify the cone width based on the provider's preference for travelling toward the target destination. The geotemporal destination system also estimates the chance that the provider will be matched with a transportation request given the current setting of the cone width. As the provider modifies the cone width setting, the geotemporal destination system updates the estimation of the chance of a transportation match.

As noted, in some embodiments, the geotemporal destination system provides, for display via the user interface of the provider device, a visual map of the transportation service area with an indication of the directional filter. For example, the geotemporal destination system displays lines of a planar cone on the map, representing bounds within which an aspect (such as a drop-off location) of a transportation request must fall for the geotemporal destination system to suggest the request to the provider device. By providing the map with the cone overlaid, the geotemporal destination system offers a visual cue to a provider of how the destination mode operates to filter transportation requests.

The geotemporal destination system also can provide a deviation angle control element for display via the user interface of the provider device. Thus, the geotemporal destination system allows the provider to control (at least in part) the extent of the directional filter. For instance, the geotemporal destination system receives user input of an increase (or decrease) in the angular width of the cone (cone width) on the map representing the transportation service area. The geotemporal destination system identifies the change to the cone width and reflects the change on the map.

For the range of possible cone widths, the geotemporal destination system can determine a likelihood that the provider device will be matched with a requester device along the route toward the target destination. For example, given a narrow cone width, the geotemporal destination system may determine that the probability of a transportation match is low. Conversely, the geotemporal destination system may determine, given a wide cone width, that the probability of a transportation match is high. The geotemporal destination system may base this determination on current numbers of requester devices and provider devices, on historical data, and/or on the setting of the cone width. In some embodiments, the geotemporal destination system utilizes a prediction model, such as a machine learning model, to determine the likelihood of a transportation match.

In some embodiments, the geotemporal destination system determines whether a transportation request satisfies the directional filter based on a destination progress metric. For example, the geotemporal destination system evaluates transportation requests based on how much closer they will get a provider device to the target destination if the provider devices services the request. Requests that make a substantial advance toward the target destination generally have a high destination progress metric. The geotemporal destination system may determine a destination progress threshold based on the user-selected (or default) threshold deviation angle. The geotemporal destination system may use the destination progress threshold to determine whether transportation requests satisfy the destination progress threshold (and therefore the directional filter).

As an alternative to receiving a target destination from the provider device, the geotemporal destination system may receive a desired radius within which the provider device will stay while servicing transportation requests. For example, the provider may wish to stay within a given area. In some embodiments, the geotemporal destination system offers a stay-nearby mode, in which the geotemporal destination system identifies a threshold radius for establishing the directional filter. In this way, the directional filter serves as a locality for keeping the provider device in, while allowing the provider device to receive and service transportation requests.

The geotemporal destination system provides many advantages and benefits over conventional systems and methods. For example, by providing a deviation angle control element together with a transportation match probability indicator, the geotemporal destination system provides improved functionality and flexibility relative to conventional systems. Specifically, the geotemporal destination system allows a provider device to select and dynamically adjust parameters for computer-implemented algorithms utilized to generate transportation matches in a destination mode while providing dynamic feedback regarding the impact of the selected parameters on transportation matches between requester and provider devices. Specifically, the geotemporal destination system allows provider devices to select and modify a threshold deviation angle and provides a corresponding dynamic transportation match probability indicator reflecting how the changed angle will impact future transportation matches. Moreover, the geotemporal destination system can generate default deviation angles and/or control deviation angle ranges to account for current and/or historical client and provider device balances within geographical regions. Accordingly, the geotemporal destination system flexibly allows for adjustment to particular context of individual provider devices without undermining efficacy of other matching algorithms or disrupting the balance between provider devices and requester devices within a geographical region.

Further, the geotemporal destination system improves efficiency relative to conventional systems. Indeed, the geotemporal destination system generates improved user interfaces that provide directional filter visibility and deviation angle control, resulting in fewer interactions, fewer user interfaces, and less utilization of processing resources. Indeed, by providing deviation control elements, the geotemporal destination system can avoid unnecessary user interactions in repeated entry of different destinations (to adjust transportation matches that are more desirable to navigate to a particular destination more quickly), user interactions in cancelling and re-initiating transportation matches, and user interactions in alternating between various modes in an attempt to control incoming matches. Thus, by providing more efficient user interfaces, including increasing functionality of the directional filter and the transportation match probability, the geotemporal destination system reduces the incidence of canceled requests, repeated requests, canceled entries into destination mode, repeated entries into destination mode, and device queries, thereby reducing the requirement for network bandwidth, memory storage, and computing resources.

Further still, by allowing a provider to select a threshold deviation angle, the geotemporal destination system improves accuracy relative to conventional systems. Specifically, the geotemporal destination system increases the number of transportation matches that align requester devices and provider devices traveling toward a particular target destination. Thus, for provider devices seeking an immediate option to travel to a particular target location, the geotemporal destination system can provide transportation matches that accurately align to this particular context. Similarly, for provider devices seeking a circuitous route that ultimately leads to a target destination, the geotemporal destination system can provide transportation matches that accurately align to this provider device context.

As indicated by the foregoing discussion, the present disclosure utilizes a variety of terms to describe features and advantages of the geotemporal destination system. For example, as used herein, the term “destination transportation matching mode” (or simply “destination mode”) refers to a mode or variation of a provider application for a transportation matching system. In particular, a destination transportation matching mode refers to a mode of a provider application wherein a provider device can indicate a target destination and can receive transportation requests based on the target destination. Indeed, for a provider device utilizing a destination transportation matching mode, the geotemporal destination system can utilize a particular set of rules or algorithms (e.g., a directional filter, an arrival time filter, and/or a radial match filter) associated with the destination transportation matching mode to identify and surface transportation requests to the provider device.

Relatedly, the term “target destination” (or simply “destination”) refers to a terminal destination selected by a provider device (e.g., a destination where the provider device will arrive without a passenger). In particular, a target destination can include a location received from a provider device that indicates a terminal destination or place to where a provider associated with the provider device would like to travel for a destination mode session. In particular, a target destination can refer to a geographical location (e.g., a latitude, a longitude, and/or an elevation) where a provider device selects to end after providing transportation services. Accordingly, a target destination can indicate a termination of a destination mode session—e.g., the geotemporal destination system can terminate a destination mode session upon determining that a provider device arrives at the target destination.

As used herein, the term “transportation request” refers to a query by a requester device seeking a transportation service. In particular, a “transportation request” can refer to a submission of a requester device to a transportation matching system to match the requester device with a provider device, thereby establishing transportation service. To illustrate, a transportation request can include information about a desired pickup location, a desired drop-off location, a desired pickup time, a desired drop-off time, a number of passengers and/or luggage, and special considerations for the transportation.

As used herein, the term “provider device” refers to a device (corresponding to a transportation provider) that seeks a transportation match with a requester device to provide transportation services. In particular, the term “provider device” can include a computing device that places a query identifying availability to transport a requester device from a geographic location to another geographic location. To illustrate, a requester device can include a mobile phone, a tablet, and a computer, any of which may search for transportation matches utilizing a mobile application or a web-based application.

As used herein, the term “requester device” refers to a device (corresponding to a requester) that submits a request for transportation services. In particular, the term “requester device” can include a computing device that places a query identifying a need for transportation from a geographic location to another geographic location. To illustrate, a requester device can include a mobile phone, a tablet, and a computer, any of which may place a request utilizing a mobile application or a web-based application.

As used herein, the terms “current provider devices” and “current requester devices” refer to provider devices and requester devices, respectively, that are currently active in a transportation matching system. In particular, the terms “current provider devices” and “current requester devices” refer to devices that are presently providing transportation or being transported, or that are presently traveling to provide transportation or waiting to be transported. To illustrate, a current provider device can include a provider device in transit to a pickup location or to a drop-off location, and a current requester device can include a requester device waiting for pickup or in transit to a drop-off location.

As used herein, the terms “historical provider devices” and “historical requester devices” refer to provider devices and requester devices, respectively, that have previously participated within the transportation matching system. In particular, the terms “historical provider devices” and “historical requester devices” refer to the provider device and requester device components of historical transportation matches. For instance, a historical provider device is an instance of a transportation service provider providing transportation utilizing the transportation matching system. The historical provider device can be as recent as within the last hour, or as distant as months or years in the past, for example. Similarly, a historical requester device is an instance of a requester receiving transportation service utilizing the transportation matching system. The historical requester device can, similar to a historical provider device, be recent or in the distant past.

As used herein, the term “transportation match” (or simply “match”) refers to a transportation request that a transportation matching system has assigned to a particular provider device. In particular, the transportation matching system generates a match that assigns a provider device to a transportation request that includes a requester device, a pickup location, and a drop-off location. The transportation matching system can provide a route to the provider device that includes navigation instructions from the current location of the provider device to the pickup location specified by the transportation match, and then from the pickup location to the drop-off location.

Relatedly, the term “transportation match probability” refers to a likelihood that a provider device will be matched with a requester device. In particular, a transportation match probability is a chance of the provider device picking up a requester device for a ride. To illustrate, a “transportation match probability” is a likelihood that the transportation matching system will generate a transportation match given the provider device's current filter settings. For example, the transportation match probability may be high when the provider device selects a wide directional filter, whereas the transportation match probability may be low when the provider device selects a narrow directional filter.

As mentioned, the geotemporal destination system can utilize a directional filter to identify transportation requests to surface to a provider device. As used herein, the term “directional filter” refers to a computer-implemented algorithm or mechanism that identifies and/or filters transportation requests based on a direction relative to a target destination (e.g., relative to a direction between a provider device location and the target destination). In particular, a directional filter can refer to a filter for identifying a transportation request to surface to a provider device and filtering out transportation requests to withhold from the provider device.

For example, the geotemporal destination system can determine a threshold deviation angle to utilize as a basis for a directional filter. As used herein, the term “deviation angle” refers to an angle relative to a target destination. In particular, a deviation angle can include an angular measure (e.g., a number of degrees or radians) relative to a first direction from the provider device location to the target destination. Specifically, the deviation angle can include the angular measure between the first direction and a second direction from the provider device location to a location associated with a transportation request (e.g., a drop-off location, a pick-up location, or a request location).

As used herein, the term “threshold deviation angle” refers to a deviation angle that represents a boundary for the directional filter. In particular, a threshold deviation angle can include a maximum deviation angle for servicing a transportation request. Specifically, the threshold deviation angle can include a span of permissible deviation angles within which the geotemporal destination system surfaces transportation requests, and outside of which the geotemporal destination system filters out transportation requests.

As also mentioned, the geotemporal destination system can utilize an arrival time filter to identify transportation requests to surface to a provider device. As used herein, the term “arrival time filter” refers to a computer-implemented algorithm or mechanism that identifies and/or filters transportation requests based on a target arrival time associated with a target destination. In particular, an arrival time filter can include rules for identifying and/or filtering out one or more transportation requests based on determining a duration of time associated with servicing the transportation request(s) and further determining whether or not a provider device would be able to arrive at a target destination by a target arrival time after servicing the transportation request(s). In some embodiments, an arrival time filter can include rules for accommodating a threshold measure of error or an arrival time margin for arriving at the target destination by a target arrival time.

Relatedly, the term “target arrival time” (or simply “arrival time”) refers to a time selected (e.g., by a provider device) to arrive at a target destination. In particular, a target arrival time can include a time of day that indicates when a provider associated with a provider device desires to arrive at an indicated target destination.

As mentioned, the geotemporal destination system can utilize a destination progress metric to filter out and/or identify transportation requests. As used herein, the term “destination progress metric” refers to a measure of progress associated with a provider device traveling toward a target destination. In particular, a destination progress metric can include a measure or amount of time or distance that a provider device has traveled toward a target destination. In some embodiments, a destination progress metric refers to a reduction in the remaining travel time it would take for a provider device to travel to a target destination. In these or other embodiments, a destination progress metric can include a ratio, a proportion, or a percentage of progress that a provider device makes per unit of total travel time (or total travel distance). For example, a destination progress metric can indicate that a provider device reduces a time remaining to travel to a target destination by at least three minutes for every ten minutes of total travel time.

As mentioned, the geotemporal destination system can utilize a radial filter to identify transportation requests to surface to a provider device. As used herein, the term “radial match filter” (or simply “radial filter”) refers to a computer-implemented algorithm or mechanism that identifies and/or filters transportation requests based on a distance relative to a location (e.g., a target destination or the current location of the provider device). In particular, a radial filter can refer to a filter for identifying a transportation request to surface to a provider device and filtering out transportation requests to withhold from the provider device. To illustrate, the geotemporal destination system may utilize a radial filter to identify transportation requests within a default radius or a user-specified radius of a target destination (e.g., a landmark or home location or even the current location of the provider device).

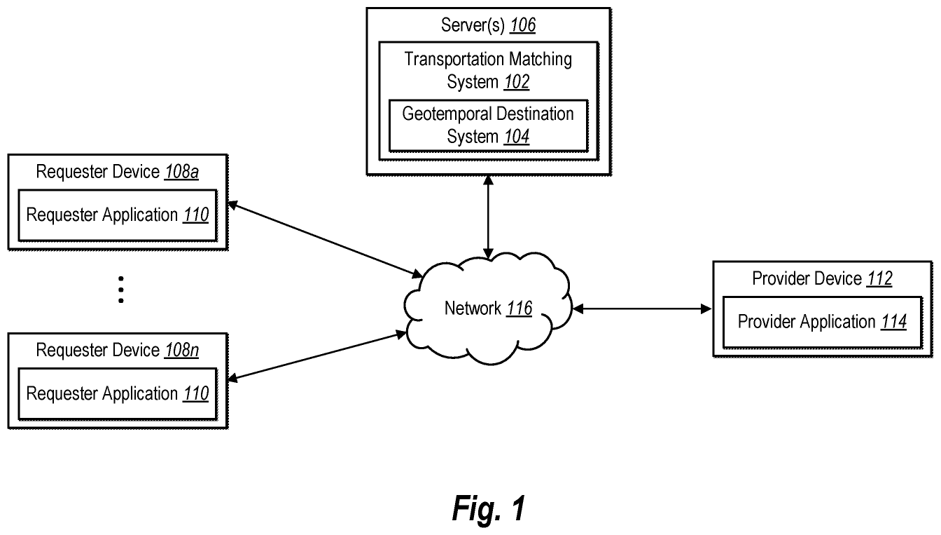

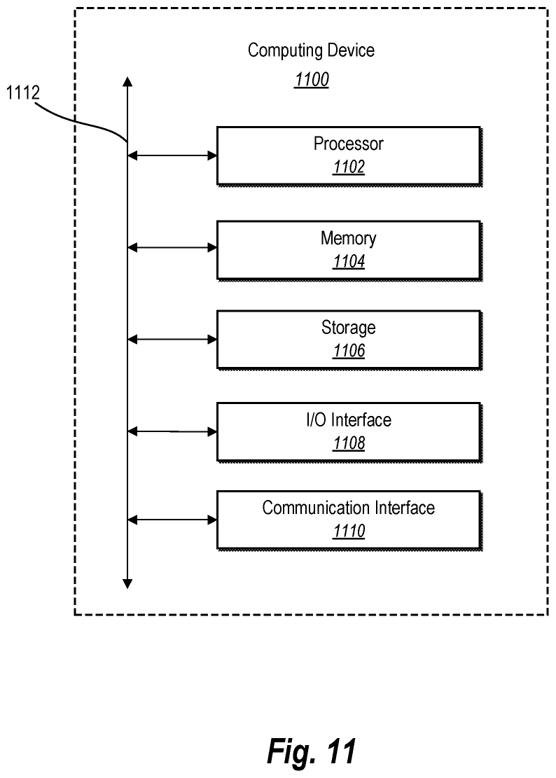

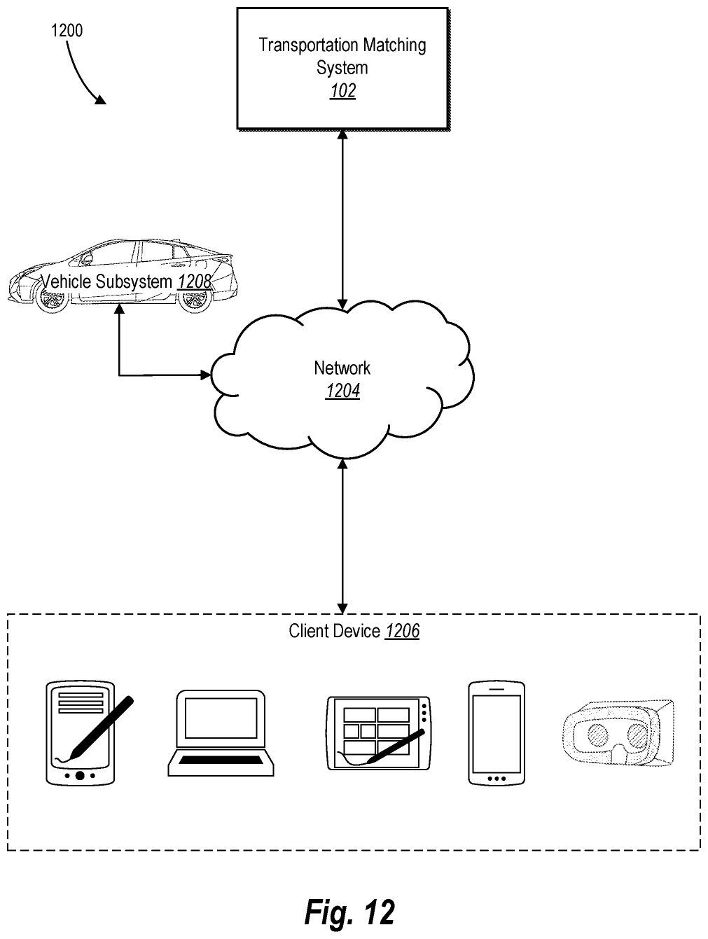

Additional detail regarding the geotemporal destination system will now be provided with reference to the figures. In particular, FIG. 1, illustrates a block diagram of a system environment for implementing a geotemporal destination system 104 in accordance with one or more embodiments. As shown in FIG. 1, the environment includes the server(s) 106 housing the geotemporal destination system 104 as part of a transportation matching system 102. The environment of FIG. 1 further includes requester devices 108a-108n, a provider device 112, and a network 116. The server(s) 106 can include one or more computing devices to implement the geotemporal destination system 104. The requester devices 108a-108n and/or the provider device 112 may be or comprise one or more of a variety of computing devices as described in FIGS. 11-12. Additional description regarding the illustrated computing devices (e.g., the server(s) 106, the requester devices 108a-108n, and/or the provider device 112) is provided with respect to FIGS. 11-12 below.

As shown, the geotemporal destination system 104 utilizes the network 116 to communicate with the requester devices 108a-108n and the provider device 112. For example, the geotemporal destination system 104 communicates with the requester devices 108a-108n and the provider device 112 to match transportation requests received from the requester devices 108a-108n with the provider device 112. Indeed, the geotemporal destination system 104 can track and communicate a status of the provider device 112 to provide an indicator for a location of the provider device 112 for display on a requester device 108a as, for example, a vehicle icon within a graphical map. In some embodiments, per device settings, the geotemporal destination system 104 receives device information from the requester devices 108a-108n and the provider device 112 (e.g., via a global positioning system associated with each device) such as location coordinates (e.g., latitude, longitude, and/or elevation) and status (e.g., currently riding, not riding, available, or unavailable) for matching requests.

To facilitate connecting requests with transportation vehicles (e.g., vehicles associated with provider devices), the geotemporal destination system 104 communicates with the requester devices 108a-108n (e.g., through a requester application 110) and the provider device 112 (e.g., through a provider application 114). As indicated by FIG. 1, the requester devices 108a-108n include a requester application 110, and the provider device 112 includes a provider application 114. In many embodiments, the geotemporal destination system 104 communicates with the requester devices 108a-108n and the provider device 112 through the requester application 110 and the provider application 114, respectively, to, for example, receive and provide information including transportation request information (e.g., pick-up locations and/or drop-off locations) and provider device information (e.g., provider device locations).

In some embodiments, the provider application 114 can include multiple transportation matching modes (e.g., a destination transportation matching mode) that each correspond to different algorithms or rule sets for matching transportation requests with the provider device 112. Additionally, the requester application 110 and the provider application 114 optionally include computer-executable instructions that, when executed by the requester devices 108a-108n and the provider device 112, cause the requester devices 108a-108n and the provider device 112 to perform certain functions as described herein.

As indicated above, the geotemporal destination system 104 can provide (or cause the provider device 112 to render) visual indicators for locations associated with transportation requests. For example, in some cases, the geotemporal destination system 104 selects the provider device 112 to service a transportation request received from one of the requester devices 108a-108n based on various factors such as a location associated with the transportation request, a provider device location, locations of other provider devices, a directional filter, an arrival time filter, provider incentives, requester incentives, a time of day, traffic information, and/or other transportation matching considerations. Based on selecting the provider device 112 to service the transportation request, the geotemporal destination system 104 provides a visual indicator for the transportation request for display within a user interface displayed on the provider device 112 (e.g., as part of the provider application 114).

Although FIG. 1 illustrates the environment having a particular number and arrangement of components associated with the geotemporal destination system 104, in some embodiments, the environment may include more or fewer components with varying configurations. For example, in some embodiments, the geotemporal destination system 104 can communicate directly with the requester devices 108a-108n, bypassing the network 116. In these or other embodiments, the geotemporal destination system 104 can be housed on and/or implemented by (entirely or in part) the provider device 112. Additionally, the geotemporal destination system 104 can include or communicate with a database for storing transportation request information, directional filter information, arrival time filter information, token information, and/or other information described herein.

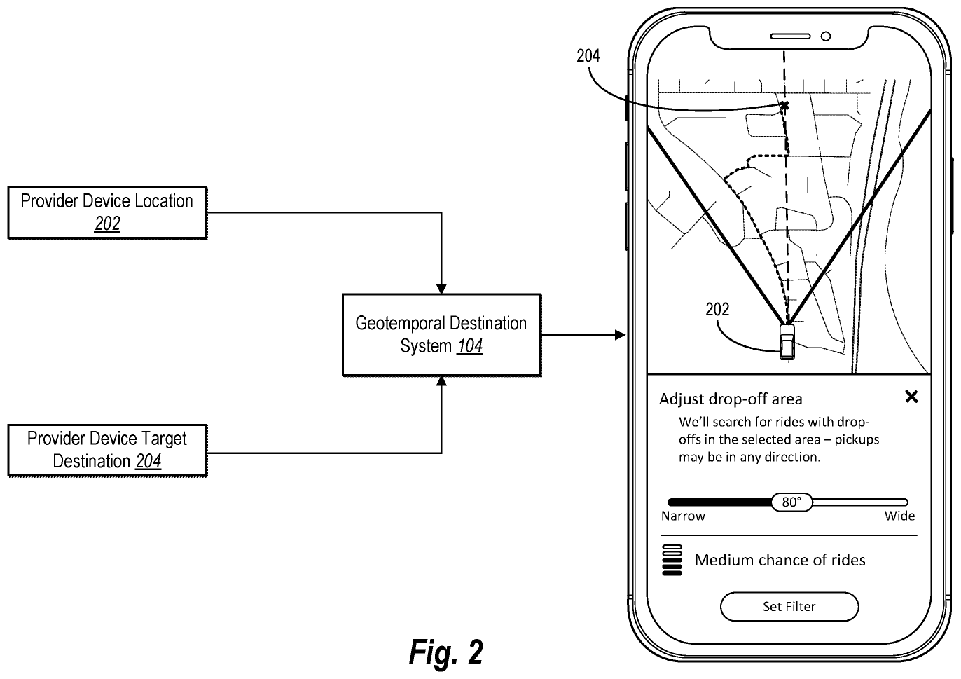

As mentioned, the geotemporal destination system 104 can provide a user interface for selecting a threshold deviation angle to generate a directional filter in a destination mode session within a transportation matching system. For instance, FIG. 2 illustrates the geotemporal destination system 104 generating a directional filter in accordance with one or more embodiments. Specifically, FIG. 2 shows the geotemporal destination system 104 receiving a provider device location 202 and a provider device target destination 204. The geotemporal destination system 104 utilizes the provider device location 202 and the provider device target destination 204 to determine a direction from the provider device location 202 to the provider device target destination 204. The geotemporal destination system 104 selects a default threshold deviation angle for a directional filter, shown on the map via the user interface of the provider device in FIG. 2 as a “cone” bracketing the direction from the provider device location 202 to the target destination 204. The cone has a cone width angle (e.g., the threshold deviation angle) that spans from one side of the cone to another.

As stated, the geotemporal destination system 104 predicts a likelihood that the provider device will receive a transportation match satisfying the directional filter. The geotemporal destination system 104 generates and displays a message on the user interface indicating the likelihood of the transportation match. For example, the geotemporal destination system 104 notifies a provider that there is a medium chance of picking up a ride request based on the current (e.g., default) setting of the threshold deviation angle.

In some embodiments, the geotemporal destination system 104 provides a deviation angle control element, such as a slider bar, on the user interface. The geotemporal destination system 104 can receive a user selection input on the deviation angle control element, changing the threshold deviation angle. Upon receiving the user selection, the geotemporal destination system 104 can update the prediction of the likelihood of a transportation match and provide the updated prediction for display. In this way, the geotemporal destination system 104 facilitates user selection of a threshold deviation angle (and corresponding directional filter) that accurately aligns provider devices and requester devices relative to the target destination 204.

In some embodiments, the geotemporal destination system 104 receives the target destination 204 as a specific location, such as a postal address or as GPS coordinates. In some embodiments, the geotemporal destination system 104 receives the target destination 204 as a generic area, such as a downtown area. The geotemporal destination system 104 may give an option to the provider device to select a mode for travelling generally to a busy area.

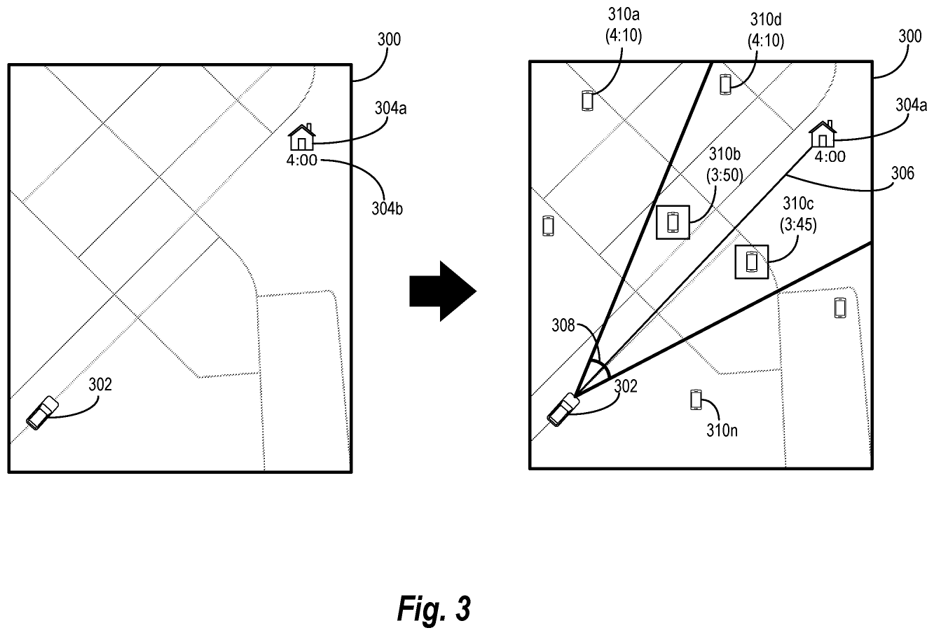

As discussed above, the geotemporal destination system 104 can utilize a directional filter and/or an arrival time filter to select a provider device to service a transportation request. In particular, the geotemporal destination system 104 can identify one or more transportation requests to provide to a provider device based on a directional filter and/or an arrival time filter. For example, FIG. 3 illustrates the geotemporal destination system 104 evaluating transportation requests based on a directional filter (e.g., a threshold deviation angle) and/or an arrival time filter in accordance with one or more embodiments.

In particular, FIG. 3 illustrates a map 300 that includes a provider device location 302. The provider device can choose to enter a geotemporal destination mode by selecting a target destination 304a and/or a target arrival time 304b. In response, the geotemporal destination system 104 can monitor transportation requests and surface those transportation requests to the provider device that satisfy a directional filter and/or arrival time filter.

Specifically, as shown in FIG. 3, the geotemporal destination system 104 identifies a plurality of transportation requests 310a-310n originating from requester devices. In addition, the geotemporal destination system 104 determines a threshold deviation angle 308 relative to a direction 306 between the provider device location 302 and the target destination 304a. Furthermore, for one or more of the transportation requests 310a-310n, the geotemporal destination system 104 determines an estimated arrival time for the target destination upon servicing the transportation request.

In some embodiments, the geotemporal destination system 104 determines whether requested drop-off locations associated with the transportation requests 310a-310n satisfy the directional filter. In some embodiments, the geotemporal destination system 104 determines whether requested pickup locations associated with the transportation requests 310a-310n satisfy the directional filter. In some embodiments, the geotemporal destination system 104 determines whether both the requested drop-off locations and the requested pickup locations associated with the transportation requests 310a-310n satisfy the directional filter.

To illustrate, the geotemporal destination system 104 selects transportation requests 310b and 310c to surface to the provider device based on the directional filter and the arrival time filter. For example, the geotemporal destination system 104 analyzes the transportation request 310a and determines that a requested drop-off location (and/or a requested pickup location) of the transportation request 310a falls outside of the threshold deviation angle 308 and fails to satisfy the arrival time threshold (e.g., the arrival time of 4:10 falls after the target arrival time 304b of 4:00). Similarly, the geotemporal destination system 104 analyzes the transportation request 310d and determines that the transportation request 310d falls within the threshold deviation angle 308, but fails to satisfy the arrival time threshold. Accordingly, the geotemporal destination system 104 denies or filters these transportation requests such that the transportation requests are not matched to the provider device.

In contrast, the geotemporal destination system 104 analyzes the transportation requests 310b and 310c and determines that both satisfy the threshold deviation angle 308 and the target arrival time. Accordingly, the geotemporal destination system 104 provides visual indicators of the transportation requests 310b and 310c for display at the provider device.

In some embodiments, the geotemporal destination system 104 provides visual indicators of the transportation requests 310b and 310c by filtering out transportation requests 310a and 310d (e.g., removing them from the map 300) displayed on the provider device. In some embodiments, the geotemporal destination system 104 provides visual indicators of the transportation requests 310b and 310c by highlighting the transportation requests 310b and 310c on the map 300. In some embodiments, the geotemporal destination system 104 provides visual indicators of the transportation requests 310b and 310c by listing them near the top of a priority listing of transportation matches.

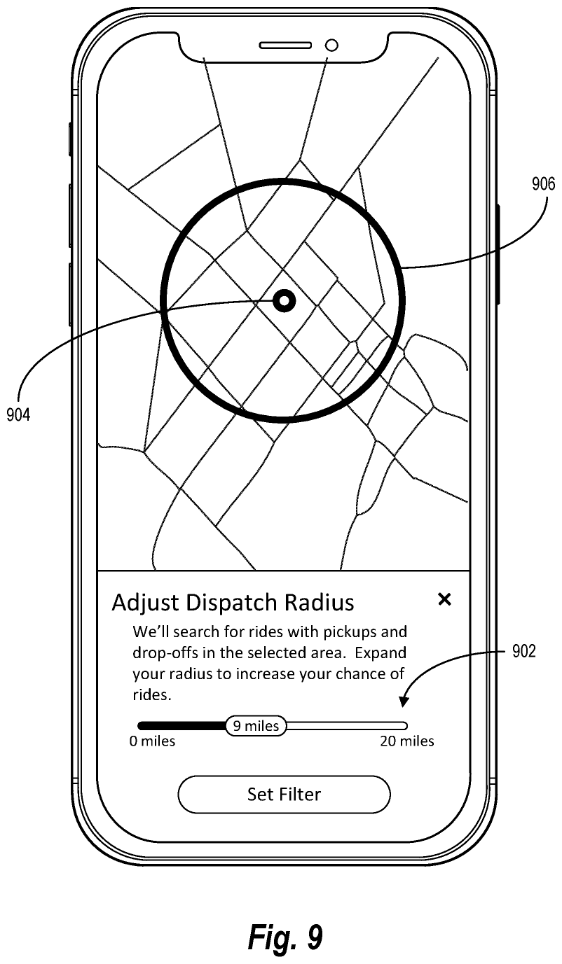

Although FIG. 3 illustrates applying both a directional filter and an arrival time filter, it will be appreciated that the geotemporal destination system 104 can apply either a directional filter or an arrival time filter depending on the embodiment and preferences of the provider device. Further, as discussed below in connection with FIG. 9, the geotemporal destination system 104 can apply a radial filter to evaluate and filter transportation requests. Indeed, as discussed in greater detail below, the geotemporal destination system 104 can customize a variety of filter settings within destination mode to improve accuracy and efficiency of transportation matches.

Further details on how the geotemporal destination system 104 applies a directional filter, an arrival time filter, and/or other filter settings can be found in U.S. patent application Ser. No. 16/790,601, entitled UTILIZING A DIRECTIONAL FILTER FOR A GEOTEMPORAL DESTINATION MODE OF A DYNAMIC TRANSPORTATION MATCHING SYSTEM, the contents of which are incorporated by reference herein in their entirety.

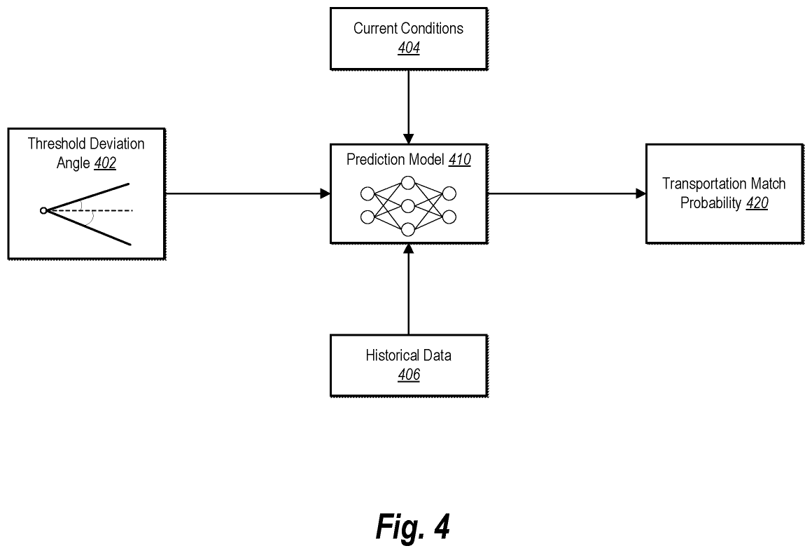

As mentioned, the geotemporal destination system 104 can determine a transportation match probability. For instance, FIG. 4 illustrates the geotemporal destination system 104 determining a transportation match probability 420 in accordance with one or more embodiments. Specifically, FIG. 4 shows the geotemporal destination system 104 utilizing a prediction model 410 to generate the transportation match probability 420. For example, the geotemporal destination system 104 identifies a threshold deviation angle 402 to input to the prediction model 410. In some embodiments, the geotemporal destination system 104 identifies a threshold deviation angle 402 by selecting a default threshold deviation angle and inputting the default threshold deviation angle to the prediction model 410. In some embodiments, the geotemporal destination system 104 identifies a threshold deviation angle 402 by receiving user input from the provider device for a threshold deviation angle. The geotemporal destination system 104 inputs the threshold deviation angle 402 into the prediction model 410. Thus, the geotemporal destination system 104 can utilize the prediction model 410 to determine the transportation match probability 420 based on the threshold deviation angle 402.

As additionally reflected in FIG. 4, the geotemporal destination system 104 can determine the transportation match probability 420 based on current conditions 404 and/or historical data 406. For instance, the geotemporal destination system 104 receives current conditions 404 such as the current provider device location, a number of current requester devices in an area local to the provider device location, and a number of current provider devices in the area local to the provider device location. The geotemporal destination system 104 may input these current conditions 404 into the prediction model 410. Further, the geotemporal destination system 104 receives (or has stored) historical data 406 such as a number of historical transportation requests in the area local to the provider device location, and a number of historical provider devices servicing the historical transportation requests. The geotemporal destination system 104 may input this historical data 406 into the prediction model 410. The geotemporal destination system 104 may utilize the prediction model 410 to evaluate the current conditions 404 and/or the historical data 406 and generate a transportation match probability.

The geotemporal destination system 104 can utilize a variety of computer-implemented algorithms for the prediction model 410. For example, in some implementations, the geotemporal destination system 104 utilizes a machine learning model, such as a trained neural network or decision tree machine learning model. For example, the geotemporal destination system 104 can train a machine learning model to generate predictions based on a variety of input features, such as location, time of day, weather, number of transportation requests (e.g., number of requester devices), and/or number of provider devices and generate a predicted transportation match probability 420.

To illustrate, the geotemporal destination system 104 can encode these input features (e.g., utilizing one hot encoding or an embedding network). The geotemporal destination system 104 can utilize layers having learned parameters to process the encoded features. At each layer, the neural network can generate intermediate latent feature vectors representing weighted features according to the learned parameters of the network. Utilizing a variety of activation, pooling, convolution layers, normalization, and/or dropout layers, the neural network can generate a prediction (e.g., a transportation match probability or a different prediction in relation to other parameters discussed herein).

During training, the geotemporal destination system 104 can learn parameters of the machine learning model. For example, the geotemporal destination system 104 can compare predictions generated by a neural network with ground truth predictions (e.g., ground truth transportation match probabilities). In some implementations, the geotemporal destination system 104 utilizes a loss function to determine a measure of loss between the prediction and the ground truth. The geotemporal destination system 104 can then modify parameters of the neural network utilizing the measure of loss. For example, the geotemporal destination system 104 can utilize gradient descent and backpropagation to modify parameters of the neural network to reduce the measure of loss. The geotemporal destination system 104 can iteratively modify parameters utilizing training predictions and ground truths to train the neural network.

In addition to machine learning models, the geotemporal destination system 104 can also utilize other models to determine a transportation match probability 420. For example, the geotemporal destination system 104 can utilize heuristic models informed by historical features. To illustrate, in some embodiments, the geotemporal destination system 104 performs A/B testing to determine a change in transportation match probability for different treatments (e.g., different threshold deviation angles). For example, the geotemporal destination system 104 can utilize a first deviation angle for a first percentage of provider devices and a second deviation angle for a second percentage of provider devices to determine a change in transportation matches.

In some circumstances, A/B testing can provide skewed results because provider devices receiving different treatments are not independent (i.e., they are operating within the same overall environment and impact other provider devices within the environment). Accordingly, in some implementations, the geotemporal destination system 104 performs a time split A/B test. In particular, the geotemporal destination system 104 utilizes a first threshold deviation angle for provider devices during a first time period and utilizes a second threshold deviation angle for provider devices during a second time period. The geotemporal destination system 104 then compares the resulting transportation matches to determine a modified transportation match probability corresponding to the different transportation angles. The geotemporal destination system 104 can measure the transportation match probability (e.g., matching rate) for different deviation angles, and utilize these measurements as predicted transportation match probabilities when a corresponding deviation angle is selected by a provider device.

In some implementations, the geotemporal destination system 104 utilizes heuristic models that consider a variety of different features informed by historical data to generate the predicted transportation match probabilities. For example, the geotemporal destination system 104 can measure historical numbers of provider devices, historical numbers of requester devices, time of day, and deviation angle used and then measure the transportation match probability (e.g., number or rate of transportation matches). The geotemporal destination system 104 can then utilize the measured transportation match probability as a predicted transportation match probability in circumstances that align with the measured features. Thus, based on historical data, the geotemporal destination system 104 can develop a heuristic model that generates predicted transportation match probabilities based on contextual features.

In some implementations, the geotemporal destination system 104 determines bins or ranges of deviation angles that correspond to bins or ranges of transportation match probabilities. For example, the geotemporal destination system 104 can map a first range of deviation angles to a first transportation match probability, a second range of deviation angles to a second transportation match probability, and a third range of deviation angles to a third transportation match probability.

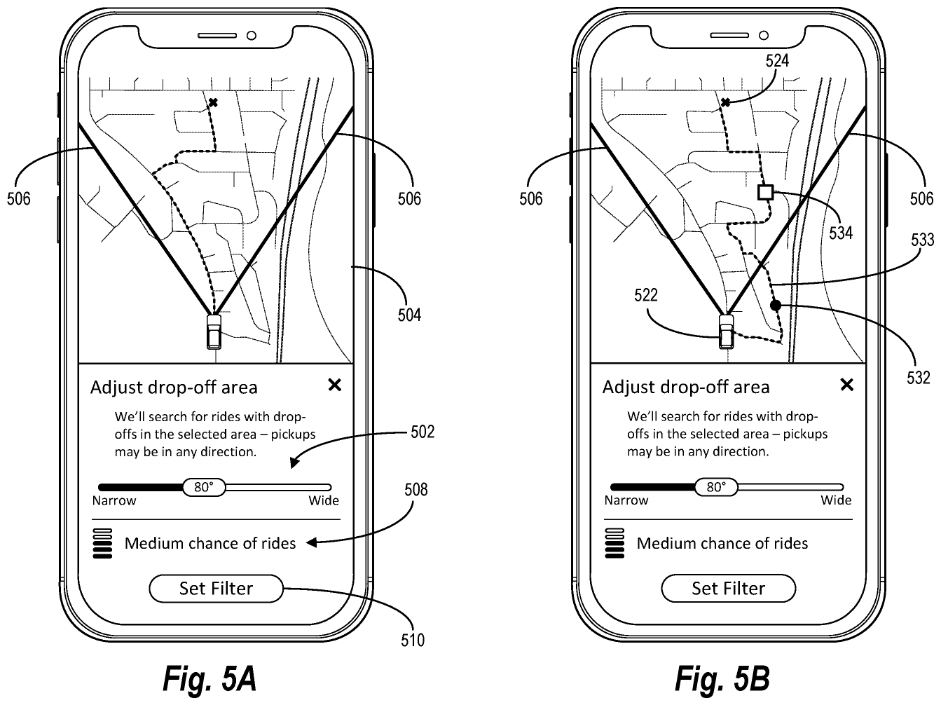

As discussed, the geotemporal destination system 104 can utilize a directional filter to identify transportation requests that advance a provider device toward a target destination. For example, FIGS. 5A-5B illustrate the geotemporal destination system 104 identifying a threshold deviation angle, determining a directional filter, and determining that a transportation request satisfies the directional filter.

Specifically, FIG. 5A illustrates the geotemporal destination system 104 receiving a user input via the provider device to set the threshold deviation angle. The geotemporal destination system 104 provides a deviation angle control element 502. The deviation angle control element 502 can be a slider bar, as depicted in FIG. 5A, or it can be another control element such as a scroll wheel or knob. The geotemporal destination system 104 provides the deviation angle control element 502 for display via a user interface 504 of the provider device. The geotemporal destination system 104 receives input from a user via the deviation angle control element 502. The geotemporal destination system 104 allows a user to selectively designate a threshold deviation angle for a target destination. For example, as shown in FIG. 5A, a user of the provider device may manipulate the deviation angle control element 502 to select a threshold deviation angle of 80 degrees. The geotemporal destination system 104 displays a directional filter, such as the boundaries of the cone 506, on a map depicting the prospective transportation service. The boundaries of the cone 506 represent geographical limits of the transportation service within the destination mode.

As mentioned, the geotemporal destination system 104 may provide a transportation match probability indicator 508 for display via the user interface. The geotemporal destination system 104 provides the transportation match probability indicator 508 to signal to a provider associated with the provider device how the selection of the threshold deviation angle affects the transportation match probability. For instance, as shown in FIG. 5A, the geotemporal destination system 104 provides a transportation match probability indicator 508 that indicates the current selection has a medium chance of resulting in a transportation match.

In some embodiments, the geotemporal destination system 104 provides a transportation match probability indicator as a qualitative statement on the likelihood of a transportation match. In some embodiments, the geotemporal destination system 104 provides a transportation match probability indicator as a quantitative estimate of the effect of the user selection, such as a percentage chance of transportation matches or a percentage decrease in potential earnings from the transportation service. In addition, the geotemporal destination system 104 can provide a transportation match probability indicator using a variety of different values or metrics. For example, the geotemporal destination system 104 can provide a transportation match probability, as an estimated time until the next match, as an estimated number of matches in a time period, as a number of filtered rides, and/or as a ratio of filtered rides relative to eligible rides (e.g., this will result in filtering 50% of eligible rides). In some embodiments, the geotemporal destination system 104 provides a number of rides that would have been compatible/filtered in a recent past period of time (e.g., three rides in the past thirty minutes would have been available).

As shown in FIG. 5A, the geotemporal destination system 104 may provide a user-selection button 510, by which a provider may finalize the selection of the threshold deviation angle and set the directional filter. Thus, the geotemporal destination system 104 allows the user to select the width of the directional filter and enter the destination mode to begin receiving transportation matches.

As discussed, the geotemporal destination system 104 can display prospective transportation matches on a map on the display via the user interface of the provider device. For example, as shown in FIG. 5B, the geotemporal destination system 104 displays the provider device 522, the boundaries of the cone 506 on the map, and the target destination 524. The geotemporal destination system 104 also displays a transportation request that satisfies the directional filter represented by the boundaries of the cone 506. Specifically, the geotemporal destination system 104 displays, via the user interface, a requester device location 532, a desired drop-off location 534 of the requester device, and a viable route 533 connecting the requester device location 532 with the desired drop-off location 534 of the requester device. In this example, the geotemporal destination system 104 recognizes the desired drop-off location 534 as within the boundaries of the cone 506, and therefore the transportation request as satisfying the directional filter. Based on determining that the transportation request satisfies the directional filter, the geotemporal destination system 104 can select the provider device to service the transportation request. Upon servicing the request, the provider device progresses generally toward the target destination 524.

In some embodiments, the geotemporal destination system 104 assigns a transportation match between a provider device and a requester device, even though a pickup location of the requester device falls outside of the directional filter. In this way, the geotemporal destination system 104 can balance the provider's desire to advance toward the target destination 524 with the provider's desire to be matched with a transportation request. In some embodiments, the geotemporal destination system 104 may filter out a transportation request that has a pickup location beyond a predetermined threshold distance outside of the directional filter (notwithstanding having a drop-off location within the directional filter). Moreover, in some implementations, the geotemporal destination system 104 applies a backtracking filter that blocks transportation requests/matches when a determined backtracking distance falls above a threshold (e.g., the transportation request requires passenger-less time/distance to a pickup location that exceeds a threshold time/distance backtracking from the target destination). In this way, the geotemporal destination system 104 prevents cancellations and inefficiencies resulting from transportation requests that appear to direct the provider away from the target destination.

As discussed, the geotemporal destination system 104 can utilize other filter settings to identify transportation requests that advance a provider device toward a target destination. For example, in some implementations, the geotemporal destination system 104 determines a destination progress metric and selects transportation matches based on the destination progress metric (e.g., in addition to the threshold deviation angle). For instance, suppose A is a driver location when matched, B is a ride drop-off location, and C is a target destination. Then, in some implementations, the geotemporal destination system 104 determines the destination progress metric (or supply progress metric, SPR) as:

SPR=((time from A to C)−(time from B to C))/(trip duration)

In some embodiments, the geotemporal destination system 104 applies a destination progress threshold and filters transportation requests/matches that fail to satisfy the destination progress threshold. Moreover, in some implementations, the geotemporal destination system 104 selects the destination progress threshold based on a threshold deviation angle.

To illustrate, the geotemporal destination system 104 can utilize a default destination progress threshold (corresponding to a default threshold deviation angle) and then modify the destination progress threshold based on user selection of a modified threshold deviation angle. For example, the geotemporal destination system 104 can utilize a default destination progress threshold of 0.1. In response to modification of a threshold deviation angle above a first trigger angle (e.g., above 120 degrees), the geotemporal destination system 104 modifies the destination progress threshold. In some implementations, the geotemporal destination system 104 linearly modifies the destination progress threshold from 0.1 to 0 at 180 degrees.

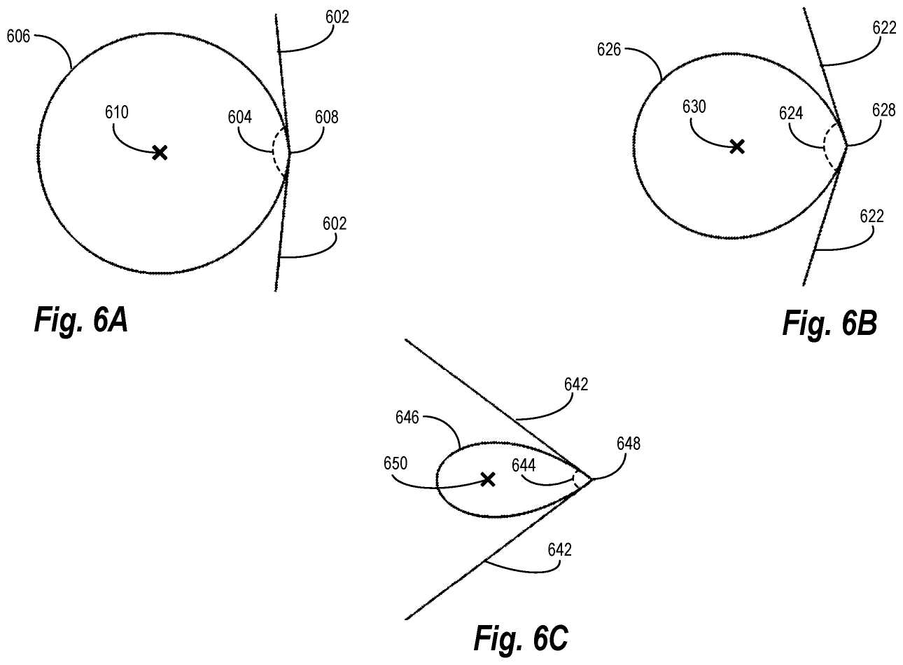

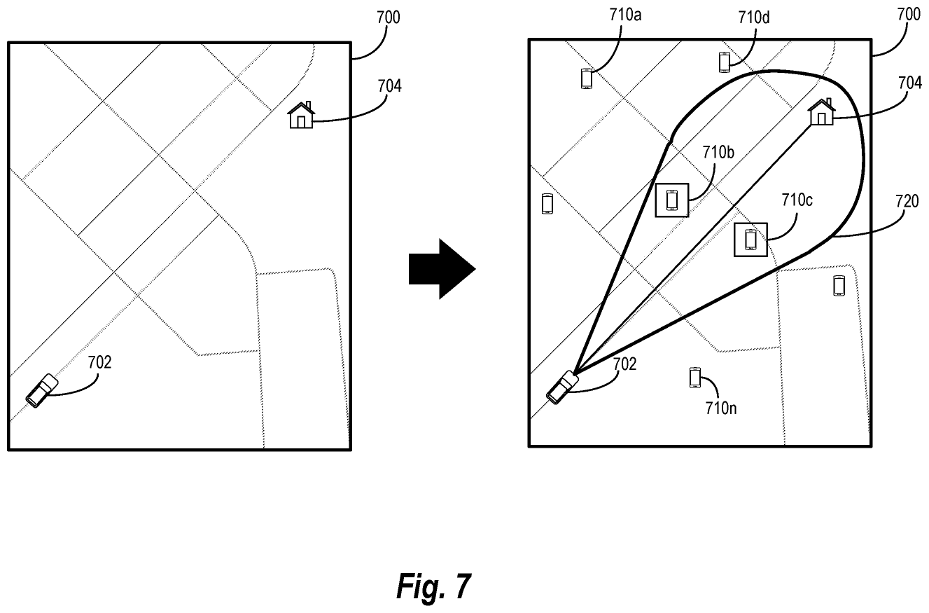

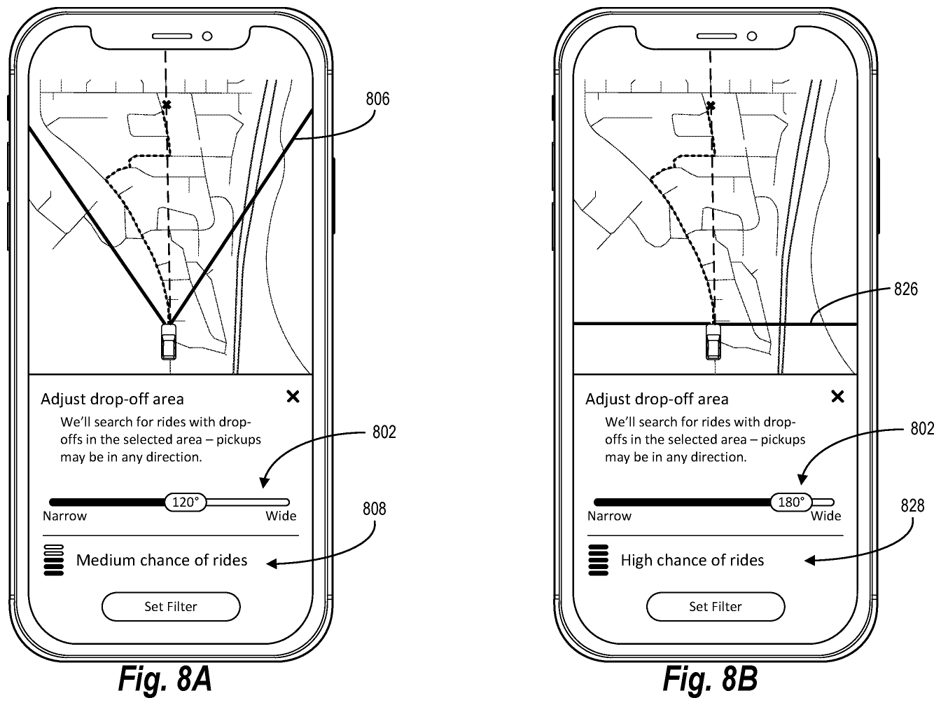

In some embodiments, the geotemporal destination system 104 determines a destination progress threshold utilizing a different mapping model that directly maps the threshold deviation angle to a destination progress threshold. For example, FIGS. 6A-6C illustrate the geotemporal destination system 104 determining a destination progress threshold based on a threshold deviation angle. As discussed, the geotemporal destination system 104 may use the destination progress threshold, alternatively to or additionally with the threshold deviation angle. The destination progress threshold is a reflection or indication of how much closer a provider device will be to a target destination after servicing a transportation request, relative to the initial distance from the provider device location to the target destination.

FIG. 6A depicts an example of a directional filter with a wide threshold deviation angle. Specifically, the threshold deviation angle is shown with cone width boundaries 602 emanating from a provider device location 608 and bracketing a target destination 610. The magnitude 604 of the threshold deviation angle is high (i.e., nearly 180 degrees). The geotemporal destination system 104 can generate a destination progress threshold that can be represented graphically as lobe 606. For threshold deviation angles that are near 180 degrees, the lobe 606 representing the destination progress threshold approximates a circle. In other words, a wide threshold deviation angle results in a small destination progress threshold. Thus, the geotemporal destination system 104 may allow transportation requests through the directional filter that might not result in the provider device getting much closer to the target destination 610.

FIG. 6B depicts an example of a directional filter with a threshold deviation angle that is narrower than that of FIG. 6A. Specifically, the threshold deviation angle is shown with cone width boundaries 622 emanating from a provider device location 628 and bracketing a target destination 630. The magnitude 624 of the threshold deviation angle is lower than the magnitude 604 from FIG. 6A. The geotemporal destination system 104 generates a destination progress threshold that can be represented graphically as lobe 626. The lobe 626 is less like a circle than the lobe 606. The destination progress threshold corresponding with FIG. 6B is larger than that of FIG. 6A, meaning that the geotemporal destination system 104 filters out more transportation requests that (with respect to the destination progress threshold of FIG. 6A) do not result in much progress for the provider device toward the target destination 630.

FIG. 6C depicts an example of a directional filter with a narrow threshold deviation angle. Specifically, the threshold deviation angle is shown with cone width boundaries 642 emanating from a provider device location 648 and bracketing a target destination 650. The magnitude 644 of the threshold deviation angle is relatively low. The geotemporal destination system 104 generates a destination progress threshold that can be represented graphically as lobe 646. The lobe 646 is very elongated, relative to lobes 606 and 626. The destination progress threshold corresponding with FIG. 6C is larger than that of FIG. 6B. Thus, the geotemporal destination system 104 filters out many transportation requests that would only slightly result in progress for the provider device toward the target destination 650.

In some embodiments, the geotemporal destination system 104 determines the destination progress threshold by converting the threshold deviation angle to the destination progress threshold. In particular, the geotemporal destination system 104 can derive the destination progress threshold such that the destination progress threshold will align to the threshold deviation angle. Indeed, as shown in FIGS. 6A-6C the lobes will necessarily fall within the region defined by the threshold deviation angle if the slope of the lobes (at the starting location) is approximately equivalent (or equal to) the slope of the lines defining the threshold deviation angle. Thus, in some implementations, the geotemporal destination system 104 determines the destination progress threshold by aligning the slope of the lobe (i.e., the region boundary) defined by the destination progress threshold with the slope of the line defining the threshold deviation angle. For example, the geotemporal destination system 104 can determine a destination progress threshold c from a threshold deviation angle θ (or vice-versa) according to the following equation:

$$θ ( c ) = ( \frac{180}{π} \cdot {tan}^{- 1} \frac{2 c \sqrt{1 - {c}^{2}}}{2 {c}^{2} - 1} ) modulo 180$$

As mentioned, the geotemporal destination system 104 can utilize the destination progress threshold to determine whether a transportation request satisfies the directional filter set by a provider device. For example, FIG. 7 illustrates the geotemporal destination system 104 evaluating transportation requests based on a directional filter (e.g., a destination progress threshold) in accordance with one or more embodiments.

In particular, FIG. 7 illustrates a map 700 that includes a provider device location 702. The provider device can choose to enter a geotemporal destination mode by selecting a target destination 704. In response, the geotemporal destination system 104 can monitor transportation requests and surface those transportation requests to the provider device that satisfy a directional filter.

Specifically, as shown in FIG. 7, the geotemporal destination system 104 identifies a plurality of transportation requests 710a-710n originating from requester devices. In addition, the geotemporal destination system 104 determines a destination progress threshold and an associated lobe 720 emanating from provider device location 702 and encompassing target destination 704.

In some embodiments, the geotemporal destination system 104 determines whether requested drop-off locations associated with the transportation requests 710a-710n satisfy the directional filter defined by the lobe 720, thereby determining whether the transportation requests 710a-710n satisfy the destination progress threshold. In some embodiments, the geotemporal destination system 104 determines whether requested pickup locations associated with the transportation requests 710a-710n satisfy the directional filter. In some embodiments, the geotemporal destination system 104 determines whether both the requested drop-off locations and the requested pickup locations associated with the transportation requests 710a-710n satisfy the directional filter.

To illustrate, the geotemporal destination system 104 selects transportation requests 710b and 710c to surface to the provider device based on the directional filter defined by the lobe 720. For example, the geotemporal destination system 104 analyzes the transportation request 710a and determines that a requested drop-off location (and/or a requested pickup location) of the transportation request 710a falls outside of the lobe 720. Similarly, the geotemporal destination system 104 analyzes the transportation request 710d and determines that the transportation request 710d falls outside of the lobe 720. Accordingly, the geotemporal destination system 104 denies or filters these transportation requests such that the transportation requests are not matched to the provider device.

In contrast, the geotemporal destination system 104 analyzes the transportation requests 710b and 710c and determines that both are within the lobe 720, thereby satisfying the directional filter defined by the lobe 720. Accordingly, the geotemporal destination system 104 provides visual indicators of the transportation requests 710b and 710c for display at the provider device.

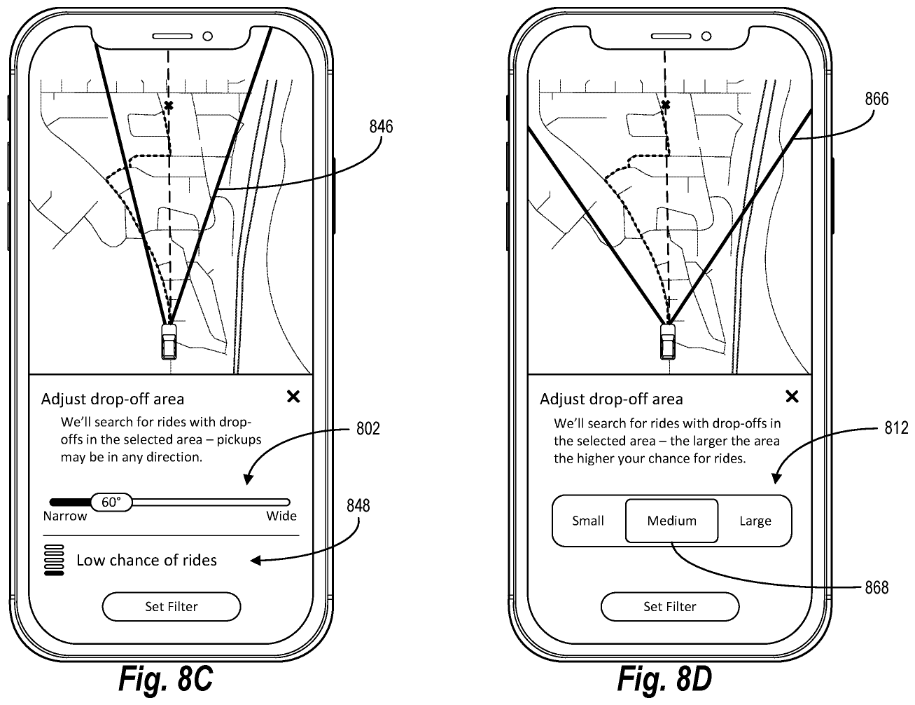

As discussed above, the geotemporal destination system 104 can provide controllability over the threshold deviation angle to a provider device. For example, FIGS. 8A-8D illustrate the geotemporal destination system 104 with varied user inputs of the threshold deviation angle, in accordance with some embodiments. For instance, the geotemporal destination system 104 provides a deviation angle control element 802 for selectively designating threshold deviation angles for a target destination.

For example, in FIG. 8A, the geotemporal destination system 104 identifies a threshold deviation angle of 120 degrees. This threshold deviation angle can be equal to a default threshold deviation angle. Alternatively, this threshold deviation angle can be different from a default threshold deviation angle. The geotemporal destination system 104 identifies this threshold deviation angle based on user interaction with the deviation angle control element 802.

Based on the provider device location, the target destination, and the threshold deviation angle, the geotemporal destination system 104 can determine a directional filter 806 for selecting transportation requests for the provider device. The geotemporal destination system 104 allows the user to manipulate the deviation angle control element 802, thereby selectively changing the size of the area of the directional filter 806 within which the user desires to service a transportation request. For instance, the geotemporal destination system 104 may receive a user input via the deviation angle control element 802 that widens the directional filter from the directional filter 806 of FIG. 8A to the directional filter 826 of FIG. 8B. As shown by way of example and not limitation, the directional filter 806 of FIG. 8A represents a 120 degree cone width, while the directional filter 826 of FIG. 8B represents a 180 degree cone width. (As mentioned, the drawings, including the directional filters represented, are not necessarily drawn to scale.)

In some embodiments, the geotemporal destination system 104 provides a transportation match probability indicator for display via the user interface of the provider device. For example, in FIG. 8A, the geotemporal destination system 104 provides a message 808 notifying the provider that the current selection of the deviation angle control element 802 at 120 degrees is associated with a medium chance of rides. In other words, based on the directional filter 806 corresponding with the user-selected threshold deviation angle, the geotemporal destination system 104 determines that the transportation match probability is medium. As described above, the geotemporal destination system 104 can utilize a prediction model to determine the transportation match probability relative to a particular threshold deviation angle (and/or other contextual factors).

As another example, in FIG. 8B, the geotemporal destination system 104 provides a message 828 notifying the provider that the current selection of the deviation angle control element 802 at 180 degrees is associated with a high chance of rides. In other words, based on the directional filter 826 corresponding with the user-selected threshold deviation angle, the geotemporal destination system 104 determines that the transportation match probability is high (e.g., as described in relation to FIG. 4).

In addition, based on user interaction with the deviation angle control element 802, FIG. 8C depicts the geotemporal destination system 104 identifying a threshold deviation angle of 60 degrees. Based on the provider device location, the target destination, and the identified threshold deviation angle, the geotemporal destination system 104 can determine a directional filter 846 with a 60 degree cone width for selecting transportation requests for the provider device.

As mentioned, the geotemporal destination system 104 may provide a transportation match probability indicator for display via the user interface of the provider device. For example, in FIG. 8C, the geotemporal destination system 104 provides a message 848 notifying the provider that the current selection of the deviation angle control element 802 at 60 degrees is associated with a low chance of rides. In other words, based on the directional filter 846 corresponding with the user-selected threshold deviation angle, the geotemporal destination system 104 determines that the transportation match probability is low (e.g., utilizing the prediction model 410).

As can be seen in FIGS. 8A-8C, the geotemporal destination system 104 can determine that, in general, setting the threshold deviation angle to a high value (as in FIG. 8B) generally increases the likelihood that the provider device will receive a transportation match, and that setting the threshold deviation angle to a lower value (as in FIG. 8C) generally decreases the likelihood that the provider device will receive a transportation match. In this way, the geotemporal destination system 104 provides new computing functionality above what is offered by conventional systems. For instance, the geotemporal destination system 104 offers to a provider the ability to toggle or manipulate the deviation angle control element 802, thereby giving a sense of how changes to the directional filter affect the likelihood of receiving a transportation match. The geotemporal destination system 104 thus increases transparency and flexibility of the transportation matching system 102. Further, by offering the added computing functionality of allowing user manipulation of the deviation angle control element 802, the geotemporal destination system 104 increases the accuracy of transportation matches to bring the provider closer to a target destination. Further still, the geotemporal destination system 104 improves computing system efficiency by reducing repeated destination mode entries and increased queries from provider devices that expend computer system bandwidth and processing time.

As mentioned, in some embodiments, the geotemporal destination system 104 selects a default threshold deviation angle. For instance, the geotemporal destination system 104 selects a default threshold deviation angle associated with a medium chance of rides, such as the 120 degree cone width shown in FIG. 8A. The geotemporal destination system 104 can base the selection of the default threshold deviation angle on any one or more of several factors. For example, the geotemporal destination system 104 selects the default threshold deviation angle based on a number of current provider devices in an area local to the provider device location (e.g., a subregion or area within which the provider device is currently located). As another example, the geotemporal destination system 104 selects the default threshold deviation angle based on a number of current requester devices in the local area. As still another example, the geotemporal destination system 104 selects the default threshold deviation angle based on historical data, such as historical requester devices and/or historical provider devices in the local area at times and seasons similar to the current use of the destination mode. In some embodiments, the geotemporal destination system 104 utilizes the prediction model 410 to select the default threshold deviation angle based on one or more of the number of current requester devices, the number of current provider devices, the number of historical requester devices, or the number of historical provider devices.

The geotemporal destination system 104 can utilize a variety of models to select a default threshold deviation angle. In some implementations, the geotemporal destination system 104 utilizes the results of A/B testing (or time split A/B testing discussed above) to select the default threshold. For instance, the geotemporal destination system 104 can determine how particular threshold deviation angles impact the number of transportation matches, wait times, number of provider devices, and the number of requester devices within the transportation matching system. The geotemporal destination system 104 can then select a default threshold deviation angle (e.g., 60 degrees) based on the results. For example, the geotemporal destination system 104 can set a threshold reduction in transportation matches, a threshold increase in wait time/ETA, etc., and select the default threshold deviation angle where historical data satisfies the threshold.

For instance, the geotemporal destination system can select a plurality of default threshold deviation angles for different contextual features of a particular geographic location/time (e.g., a first default threshold deviation angle for a first measure of provider devices/requester devices and a second default threshold deviation angle for a second measure of provider devices/requester devices). To illustrate, when the geotemporal destination system 104 detects a device imbalance of more requester devices relative to provider devices, the system can utilize a narrower default threshold deviation angle (e.g., because of the relative ease in identifying a transportation match given the device imbalance). Conversely, when the geotemporal destination system 104 detects a relatively equal number of provider devices and requester devices, the system can utilize a broader default threshold deviation angle.

In some implementations, the geotemporal destination system 104 can select the default threshold deviation angle utilizing an optimization model. For example, the geotemporal destination system 104 can analyze the current and historical contextual factors (e.g., number of provider devices and number of requester devices) and utilize a cost function that analyzes an anticipated change in transportation matches (or time or revenue) associated with applying a directional filter, an anticipated change of requester devices (e.g., for increasing wait times or ETA), and/or an anticipated change in provider devices (e.g., lost or gained drivers for setting the threshold deviation angle).

In one or more embodiments, the geotemporal destination system 104 can train a machine learning model to select a default threshold deviation angle. For example, as discussed above, the geotemporal destination system 104 can analyze a variety of input features and predict an optimal default threshold deviation angle based on the features. The geotemporal destination system 104 can utilize a ground truth default threshold deviation angle to train the machine learning model to select a default threshold deviation angle for any particular contextual inputs.

In some embodiments, the geotemporal destination system 104 selects a default threshold deviation angle based on a purpose or classification associated with a provider device using the destination mode. For example, the geotemporal destination system 104 may display a purpose query at the provider device (e.g., asking whether the provider intends to commute to work or to home, whether the provider intends to travel to a downtown region or to a busy area, whether the provider intends to travel to an airport, etc.). The geotemporal destination system 104 can provide different threshold deviation angles based on the classification (e.g., a wide threshold deviation angle for a classification of traveling to a busy area and a narrow threshold deviation angle for a classification of traveling to work or home).

In some embodiments, the geotemporal destination system 104 provides the default threshold deviation angle for display via the user interface. For example, when a provider first enters the destination mode, the geotemporal destination system 104 displays an initial threshold deviation angle equal to the default threshold deviation angle.

As mentioned, in some embodiments, the geotemporal destination system 104 selects a minimum threshold deviation angle. For instance, the geotemporal destination system 104 selects a minimum threshold deviation angle associated with a predetermined lower bound of the transportation match probability. For example, the geotemporal destination system 104 selects a minimum threshold deviation angle of a 60 degree cone width, as shown in FIG. 8C.

The geotemporal destination system 104 can base the selection of the minimum threshold deviation angle on any one or more of several factors. For example, the geotemporal destination system 104 selects the minimum threshold deviation angle based on the number of current provider devices in the area local to the provider device location (e.g., a subregion or area within which the provider device is currently located). As another example, the geotemporal destination system 104 selects the minimum threshold deviation angle based on the number of current requester devices in the local area. As still another example, the geotemporal destination system 104 selects the minimum threshold deviation angle based on historical data, such as historical requester devices and/or historical provider devices in the local area at times and seasons similar to the current use of the destination mode. In some embodiments, the geotemporal destination system 104 utilizes the prediction model 410 to select the minimum threshold deviation angle based on one or more of the number of current requester devices, the number of current provider devices, the number of historical requester devices, or the number of historical provider devices.

In some embodiments, the geotemporal destination system 104 provides the minimum threshold deviation angle for display via the user interface. For example, when a provider manipulates the deviation angle control element 802 to a lower bound, the geotemporal destination system 104 displays the minimum threshold deviation angle. The geotemporal destination system 104 may limit the deviation angle control element 802 so as not to move to a value lower than the minimum threshold deviation angle. In some embodiments, the geotemporal destination system 104 provides a message to the provider device that the currently selected threshold deviation angle is the minimum threshold deviation angle.

In some embodiments, the geotemporal destination system 104 determines a threshold deviation angle range. The threshold deviation angle range may comprise the minimum threshold deviation angle. The threshold deviation angle range may comprise a maximum threshold deviation angle. The maximum threshold deviation angle may, in some embodiments, exceed 180 degrees. The geotemporal destination system 104 may limit the deviation angle control element 802 to the threshold deviation angle range.

As discussed above with regard to the default threshold deviation angle, the geotemporal destination system 104 can select the minimum threshold deviation angle and the maximum threshold deviation angle (e.g., the threshold deviation range) based on a variety of approaches. For instance, the geotemporal destination system 104 can utilize the results of historical testing (e.g., time split A/B testing) to select a minimum and/or maximum threshold deviation angle. As mentioned, the geotemporal destination system 104 can analyze changes to the number of transportation matches, ETA, wait times, number of provider devices, and/or number of requester devices based on different threshold deviation angles and select a minimum and/or maximum threshold deviation to stay within acceptable limitations/thresholds with regard to measured changes. Similarly, the geotemporal destination system 104 can utilize an optimization model (or machine learning model) to select a minimum threshold deviation angle based on the particular contextual features at a particular time. Moreover, the system can utilize the features and factors discussed above (with regard to the default threshold deviation angle) to select an angle range (e.g., select a first minimum and maximum for a first number/balance of provider devices and requester devices, and select a second minimum and maximum for a second number/balance of provider devices and requester devices).

FIG. 8D illustrates the geotemporal destination system 104 generating and providing a user interface in accordance with some embodiments. For example, the geotemporal destination system 104 provides a deviation angle control element 812 for selectively designating threshold deviation angles for a target destination. The deviation angle control element 812 includes, for example, various selectable threshold deviation angles that correspond with various sizes of directional filter 866. For instance, as shown in FIG. 8D, the geotemporal destination system 104 can receive a user selection of a small, a medium, or a large threshold deviation angle. The geotemporal destination system 104 may display a message indicating that the selection of the size of the threshold deviation angle corresponds with a particular likelihood of receiving a transportation match. The geotemporal destination system 104 may display the directional filter 866 on a map interface via the user interface of the provider device.

As mentioned, the geotemporal destination system 104 may provide a transportation match probability indicator for display via the user interface of the provider device. For example, as depicted in FIG. 8D, the geotemporal destination system 104 provides a transportation match probability indicator 868 (e.g., a box, circle, highlight, or other selection indicator) notifying the provider that the current selection of the deviation angle control element 812 is set to “Medium,” which is associated with a medium threshold deviation angle and, correspondingly, a medium chance of rides. In other words, based on the directional filter 866 corresponding with the user-selected threshold deviation angle of “Medium,” the geotemporal destination system 104 determines that the transportation match probability is medium.

As discussed previously, the geotemporal destination system 104 can offer a radial filter option for the destination transportation matching mode. For instance, FIG. 9 illustrates the geotemporal destination system 104 providing a radial filter in accordance with some embodiments.

In the stay-nearby mode, the geotemporal destination system 104 can provide a dispatch radius control element 902 for selectively designating a threshold deviation radius for a transportation match. For example, a provider of a transportation service may wish to remain in an area local to a target location 904.

In some embodiments, the geotemporal destination system 104 identifies a threshold deviation radius 906. For example, the geotemporal destination system 104 selects a default threshold deviation radius and displays it via the user interface of the provider device. The geotemporal destination system 104 may detect user interaction with the dispatch radius control element 902 and identify, based on the user interaction, a user-selected threshold deviation radius. Whether it be the default threshold deviation radius or a user-selected threshold deviation radius, the geotemporal destination system 104 displays this threshold deviation radius 906. The geotemporal destination system can 104 also provides selectable elements for choosing a particular target location 904 (e.g., a current location, home, work, or another location or region).

The geotemporal destination system 104 may determine a directional filter based on the target location 904 and the threshold deviation radius 906. In the stay-nearby mode, the directional filter may function as a constraint on how far a provider device may deviate from a target location. For example, the threshold deviation radius 906 is a maximum permissible distance from the target location 904 that a transportation request may take the provider device. As another example, the threshold deviation radius 906 is a maximum permissible driving time from the target location 904 that the transportation request may take the provider device. Thus, the geotemporal destination system 104 may utilize a directional filter to ensure that transportation requests surfaced to the provider device are directed within the threshold deviation radius 906.

For instance, the geotemporal destination system 104 may filter out transportation requests that originate (e.g., the pickup location) outside of the threshold deviation radius 906. Similarly, the geotemporal destination system 104 may filter out transportation requests that end (e.g., the drop-off location) outside of the threshold deviation radius 906. In some embodiments, the geotemporal destination system 104 filters out transportation requests that both originate and end outside of the threshold deviation radius 906, while permitting (e.g., surfacing to the provider device) requests that have at least a pickup location or a drop-off location within the threshold deviation radius 906.

In some embodiments, the geotemporal destination system 104 provides a transportation match probability indicator based on the target location 904 and the threshold deviation radius 906. In this way, similar to the description above regarding user selection of a threshold deviation angle, the geotemporal destination system 104 provides improved functionality and flexibility that allows provider devices to dynamically control and understand the likelihood of receiving a transportation match while in destination mode.

Similar to selecting a minimum threshold deviation angle, as described above, the geotemporal destination system 104 may select a minimum threshold deviation radius for the stay-nearby mode. The system may base its selection of the minimum threshold deviation radius on one or more of current requester devices, current provider devices, historical requester devices, or historical provider devices, in or near the area defined by the target location 904 and the threshold deviation radius 906.

In some embodiments, the geotemporal destination system 104 provides, for display via the user interface of the provider device, a map of subregions. The geotemporal destination system 104 may determine a directional filter based on user selection of one or more subregions, and thus filter out transportation requests that fall outside (e.g., pickup location, drop-off location, or both) of the selected group of subregions.

In some embodiments, the geotemporal destination system 104 detects that a provider device leaves the area defined by the target location 904 and the threshold deviation radius 906. Upon detecting that the provider device has left the area, the geotemporal destination system 104 may remove the directional filter, thereby exiting stay-nearby mode, so that the provider device may receive transportation matches outside of the directional filter.

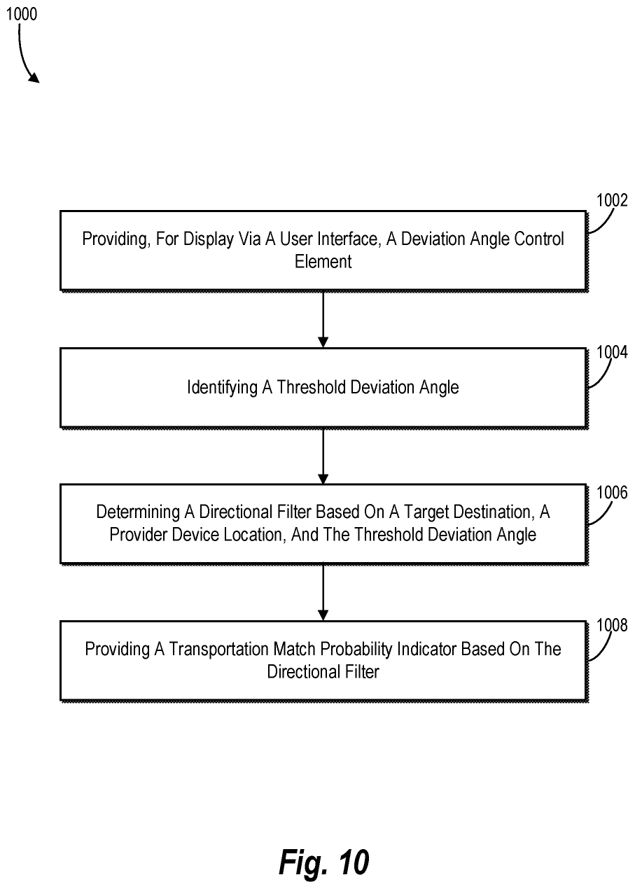

FIGS. 1-9, the corresponding text, and the examples provide a number of different methods, systems, devices, and non-transitory computer-readable media of the geotemporal destination system 104. In addition to the foregoing, one or more embodiments can also be described in terms of flowcharts comprising acts for accomplishing a particular result, as shown in FIG. 10. FIG. 10 may be performed with more or fewer acts. Further, the acts may be performed in differing orders. Additionally, the acts described herein may be repeated or performed in parallel with one another or parallel with different instances of the same or similar acts.

As mentioned, FIG. 10 illustrates a flowchart of a series of acts 1000 for providing deviation angle control and transportation match probability indications in accordance with one or more embodiments. While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer-readable medium can comprise instructions that, when executed by one or more processors, cause a computing device to perform the acts of FIG. 10. In some embodiments, a system can perform the acts of FIG. 10.

As shown in FIG. 10, the series of acts 1000 includes acts 1002-1008 of providing, for display via a user interface, a deviation angle control element; identifying a threshold deviation angle; determining a directional filter based on a target destination, a provider device location, and the threshold deviation angle; and providing a transportation match probability indicator based on the directional filter.

For example, in one or more embodiments, the acts 1002-1008 include providing, for display via a user interface of a provider device, a deviation angle control element for selectively designating threshold deviation angles for a target destination selected by the provider device; identifying a threshold deviation angle, based on user interaction with the deviation angle control element; determining a directional filter for selecting transportation requests for the provider device based on the target destination, a provider device location, and the threshold deviation angle; and providing, for display via the user interface, a transportation match probability indicator based on the directional filter.

For example, in some embodiments, the series of acts 1000 further includes determining that a transportation request satisfies the directional filter; and based on determining that the transportation request satisfies the directional filter, selecting the provider device to service the transportation request.

Moreover, in some implementations, the series of acts 1000 further includes determining, based on the threshold deviation angle, a destination progress threshold reflecting a reduction in travel to the target destination for the provider device due to servicing the transportation request; and determining that the transportation request satisfies the directional filter by determining that the transportation request satisfies the destination progress threshold.

In some implementations, the series of acts 1000 further includes determining, utilizing a prediction model, a transportation match probability based on the threshold deviation angle; and generating the transportation match probability indicator based on the transportation match probability.

Further, in one or more embodiments, the series of acts 1000 further includes providing, for display via the user interface, a default threshold deviation angle; and selecting the default threshold deviation angle based on a number of current provider devices in an area local to the provider device location and a number of current requester devices in the area.

In addition, in some implementations, the series of acts 1000 further includes determining a threshold deviation angle range comprising a minimum threshold deviation angle; limiting the deviation angle control element to the threshold deviation angle range; and selecting the minimum threshold deviation angle based on a number of current requester devices in an area local to the provider device location.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., the server(s) 106, the provider device 112, or the requester devices 108a-108n). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes the memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes the storage device 1106 for storing data or instructions. As an example, and not by way of limitation, the storage device 1106 can include a non-transitory storage medium described above. The storage device 1106 may include a hard disk drive (“HDD”), flash memory, a Universal Serial Bus (“USB”) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (“NIC”) or network adapter for communicating with an Ethernet or other wire-based network or a wireless NIC (“WNIC”) or wireless adapter for communicating with a wireless network, such as a WI-FI. The computing device 1100 can further include the bus 1112. The bus 1112 can include hardware, software, or both that connects components of computing device 1100 to each other.

Each of the components of the geotemporal destination system 104 can include software, hardware, or both. For example, the components can include one or more instructions stored on a computer-readable storage medium and executable by processors of one or more computing devices, such as a client device or server device. When executed by the one or more processors, the computer-executable instructions of the geotemporal destination system 104 can cause the computing device(s) to perform the methods described herein. Alternatively, the components can include hardware, such as a special purpose processing device to perform a certain function or group of functions. Alternatively, the components of the geotemporal destination system 104 can include a combination of computer-executable instructions and hardware.

Furthermore, the components of the geotemporal destination system 104 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

FIG. 12 illustrates an example network environment 1200 of a transportation matching system (e.g., the transportation matching system 102). The network environment 1200 includes a client device 1206, a transportation matching system 102, and a vehicle subsystem 1208 connected to each other by a network 1204. Although FIG. 12 illustrates a particular arrangement of the client device 1206, the transportation matching system 102, the vehicle subsystem 1208, and the network 1204, this disclosure contemplates any suitable arrangement of the client device 1206, the transportation matching system 102, the vehicle subsystem 1208, and the network 1204. As an example, and not by way of limitation, two or more of the client device 1206, the transportation matching system 102, and the vehicle subsystem 1208 communicate directly, bypassing the network 1204. As another example, two or more of the client device 1206, the transportation matching system 102, and the vehicle subsystem 1208 may be physically or logically co-located with each other in whole or in part. Moreover, although FIG. 12 illustrates a particular number of the client devices 1206, the transportation matching systems 102, the vehicle subsystems 1208, and the networks 1204, this disclosure contemplates any suitable number of the client devices 1206, the transportation matching systems 102, the vehicle subsystems 1208, and the networks 1204. As an example, and not by way of limitation, the network environment 1200 may include multiple client devices 1206, multiple transportation matching systems 102, multiple vehicle subsystems 1208, and multiple networks 1204.

This disclosure contemplates any suitable network 1204. As an example, and not by way of limitation, one or more portions of the network 1204 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 1204 may include one or more networks 1204.

Links may connect the client device 1206, the transportation matching system 102, and the vehicle subsystem 1208 to the network 1204 or to each other. This disclosure contemplates any suitable links. In particular embodiments, one or more links include one or more wireline (such as, for example, Digital Subscriber Line (“DSL”) or Data Over Cable Service Interface Specification (“DOCSIS”)), wireless (such as, for example, Wi-Fi or Worldwide Interoperability for Microwave Access (“WiMAX”)), or optical (such as, for example, Synchronous Optical Network (“SONET”) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by the client device 1206. As an example, and not by way of limitation, a client device 1206 may include any of the computing devices discussed above in relation to FIG. 11. A client device 1206 may enable a network user at the client device 1206 to access a network. A client device 1206 may enable its user to communicate with other users at other client devices 1206.

In particular embodiments, the client device 1206 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1206 may enter a Uniform Resource Locator (“URL”) or other address directing the web browser to a particular server (such as the server(s) 106), and the web browser may generate a Hyper Text Transfer Protocol (“HTTP”) request and communicate the HTTP request to the server. The server may accept the HTTP request and communicate to the client device 1206 one or more Hyper Text Markup Language (“HTML”) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the transportation matching system 102 may be a network-addressable computing system that can host a ride share transportation network. The transportation matching system 102 may generate, store, receive, and send data, such as, for example, user-profile data, concept-profile data, text data, ride request data, GPS location data, provider data, requester data, vehicle data, or other suitable data related to the ride share transportation network. This may include authenticating the identity of providers and/or vehicles who are authorized to provide ride services through the transportation matching system 102. In addition, the transportation service system may manage identities of service requesters such as users/requesters. In particular, the transportation service system may maintain requester data such as driving/riding histories, personal data, or other user data in addition to navigation and/or traffic management services or other location services (e.g., GPS services).

In particular embodiments, the transportation matching system 102 may manage ride matching services to connect a user/requester with a vehicle and/or provider. By managing the ride matching services, the transportation matching system 102 can manage the distribution and allocation of vehicle subsystem resources and user resources such as GPS location and availability indicators, as described herein.

The transportation matching system 102 may be accessed by the other components of the network environment 1200 either directly or via network 1204. In particular embodiments, the transportation matching system 102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 1206 or the transportation matching system 102 to manage, retrieve, modify, add, or delete, the information stored in data storage.

In particular embodiments, the transportation matching system 102 may provide users with the ability to take actions on various types of items or objects, supported by the transportation matching system 102. As an example, and not by way of limitation, the items and objects may include ride share networks to which users of the transportation matching system 102 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 102 or by an external system of a third-party system, which is separate from the transportation matching system 102 and coupled to the transportation matching system 102 via the network 1204.

In particular embodiments, the transportation matching system 102 may be capable of linking a variety of entities. As an example, and not by way of limitation, the transportation matching system 102 may enable users to interact with each other or other entities, or to allow users to interact with these entities through an application programming interfaces (“API”) or other communication channels.

In particular embodiments, the transportation matching system 102 may include a variety of servers, sub-systems, programs, modules, logs, and data stores. In particular embodiments, the transportation matching system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The transportation matching system 102 may also include suitable components such as network interfaces, security mechanisms, load balancers, failover servers, management-and-network-operations consoles, other suitable components, or any suitable combination thereof. In particular embodiments, the transportation matching system 102 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the transportation matching system 102 and one or more client devices 1206. An action logger may be used to receive communications from a web server about a user's actions on or off the transportation matching system 102. In conjunction with the action log, a third-party-content-object log may be maintained of user exposures to third-party-content objects. A notification controller may provide information regarding content objects to the client device 1206. Information may be pushed to the client device 1206 as notifications, or information may be pulled from the client device 1206 responsive to a request received from the client device 1206. Authorization servers may be used to enforce one or more privacy settings of the users of the transportation matching system 102. A privacy setting of a user determines how particular information associated with a user can be shared. The authorization server may allow users to opt in to or opt out of having their actions logged by the transportation matching system 102 or shared with other systems, such as, for example, by setting appropriate privacy settings. Third-party-content-object stores may be used to store content objects received from third parties. Location stores may be used for storing location information received from the client devices 1206 associated with users.

In addition, the vehicle subsystem 1208 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1208 can include an autonomous vehicle—e.g., a vehicle that does not require a human operator. In these embodiments, the vehicle subsystem 1208 can perform maneuvers, communicate, and otherwise function without the aid of a human provider, in accordance with available technology.

In particular embodiments, the vehicle subsystem 1208 may include one or more sensors incorporated therein or associated thereto. For example, sensor(s) can be mounted on the top of the vehicle subsystem 1208 or else can be located within the interior of the vehicle subsystem 1208. In certain embodiments, the sensor(s) can be located in multiple areas at once i.e., split up throughout the vehicle subsystem 1208 so that different components of the sensor(s) can be placed in different locations in accordance with optimal operation of the sensor(s). In these embodiments, the sensor(s) can include a LIDAR sensor and an inertial measurement unit (“IMU”) including one or more accelerometers, one or more gyroscopes, and one or more magnetometers. The sensor suite can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1208 may include a communication device capable of communicating with the client device 1206 and/or the transportation matching system 102. For example, the vehicle subsystem 1208 can include an on-board computing device communicatively linked to the network 1204 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
providing, for display via a user interface of a provider device, a deviation angle control element for selectively designating threshold deviation angles for a target destination selected by the provider device;
based on user interaction with the deviation angle control element, identifying a threshold deviation angle;
determining a directional filter for selecting transportation requests for the provider device based on the target destination, a provider device location, and the threshold deviation angle; and
providing, for display via the user interface, a transportation match probability indicator based on the directional filter.

2. The computer-implemented method of claim 1, further comprising:
determining that a transportation request satisfies the directional filter; and
based on determining that the transportation request satisfies the directional filter, selecting the provider device to service the transportation request.

3. The computer-implemented method of claim 2, further comprising:
determining, based on the threshold deviation angle, a destination progress threshold reflecting a reduction in travel to the target destination for the provider device due to servicing the transportation request; and
determining that the transportation request satisfies the directional filter by determining that the transportation request satisfies the destination progress threshold.

4. The computer-implemented method of claim 1, further comprising:
determining, utilizing a prediction model, a transportation match probability based on the threshold deviation angle; and
generating the transportation match probability indicator based on the transportation match probability.

5. The computer-implemented method of claim 1, further comprising providing, for display via the user interface, a default threshold deviation angle.

6. The computer-implemented method of claim 5, further comprising selecting the default threshold deviation angle based on a number of current provider devices in an area local to the provider device location and a number of current requester devices in the area.

7. The computer-implemented method of claim 1, further comprising:
determining a threshold deviation angle range comprising a minimum threshold deviation angle; and
limiting the deviation angle control element to the threshold deviation angle range.

8. The computer-implemented method of claim 7, further comprising selecting the minimum threshold deviation angle based on a number of current requester devices in an area local to the provider device location.

9. A non-transitory computer-readable medium storing instructions that, when executed by at least one processor, cause a computer system to:
provide, for display via a user interface of a provider device, a deviation angle control element for selectively designating threshold deviation angles for a target destination selected by the provider device;
based on user interaction with the deviation angle control element, identify a threshold deviation angle;
determine a directional filter for selecting transportation requests for the provider device based on the target destination, a provider device location, and the threshold deviation angle; and
provide, for display via the user interface, a transportation match probability indicator based on the directional filter.

10. The non-transitory computer-readable medium of claim 9, further comprising instructions that, when executed by the at least one processor, cause the computer system to:
determine that a transportation request satisfies the directional filter; and
based on determining that the transportation request satisfies the directional filter, select the provider device to service the transportation request.

11. The non-transitory computer-readable medium of claim 10, further comprising instructions that, when executed by the at least one processor, cause the computer system to:
determine, based on the threshold deviation angle, a destination progress threshold reflecting a reduction in travel to the target destination for the provider device due to servicing the transportation request; and
determine that the transportation request satisfies the directional filter by determining that the transportation request satisfies the destination progress threshold.

12. The non-transitory computer-readable medium of claim 9, further comprising instructions that, when executed by the at least one processor, cause the computer system to:
determine, utilizing a prediction model, a transportation match probability based on the threshold deviation angle; and
generate the transportation match probability indicator based on the transportation match probability.

13. The non-transitory computer-readable medium of claim 9, further comprising instructions that, when executed by the at least one processor, cause the computer system to:
select a default threshold deviation angle based on a number of current provider devices in an area local to the provider device location and a number of current requester devices in the area; and
provide, for display via the user interface, the default threshold deviation angle.

14. The non-transitory computer-readable medium of claim 9, further comprising instructions that, when executed by the at least one processor, cause the computer system to:
select a minimum threshold deviation angle based on a number of current requester devices in an area local to the provider device location;
determine a threshold deviation angle range comprising the minimum threshold deviation angle; and
limit the deviation angle control element to the threshold deviation angle range.

15. A system comprising:
at least one processor; and
at least one non-transitory computer-readable storage medium storing instructions that, when executed by the at least one processor, cause the system to:
provide, for display via a user interface of a provider device, a deviation angle control element for selectively designating threshold deviation angles for a target destination selected by the provider device;
based on user interaction with the deviation angle control element, identify a threshold deviation angle;
determine a directional filter for selecting transportation requests for the provider device based on the target destination, a provider device location, and the threshold deviation angle; and
provide, for display via the user interface, a transportation match probability indicator based on the directional filter.

16. The system of claim 15, further comprising instructions that, when executed by the at least one processor, cause the system to:
determine that a transportation request satisfies the directional filter; and
based on determining that the transportation request satisfies the directional filter, select the provider device to service the transportation request.

17. The system of claim 16, further comprising instructions that, when executed by the at least one processor, cause the system to:
determine, based on the threshold deviation angle, a destination progress threshold reflecting a reduction in travel to the target destination for the provider device due to servicing the transportation request; and
determine that the transportation request satisfies the directional filter by determining that the transportation request satisfies the destination progress threshold.

18. The system of claim 15, further comprising instructions that, when executed by the at least one processor, cause the system to:
determine, utilizing a prediction model, a transportation match probability based on the threshold deviation angle; and
generate the transportation match probability indicator based on the transportation match probability.

19. The system of claim 15, further comprising instructions that, when executed by the at least one processor, cause the system to:
select a default threshold deviation angle based on a number of current provider devices in an area local to the provider device location and a number of current requester devices in the area; and
provide, for display via the user interface, the default threshold deviation angle.

20. The system of claim 15, further comprising instructions that, when executed by the at least one processor, cause the system to:
select a minimum threshold deviation angle based on a number of current requester devices in an area local to the provider device location;
determine a threshold deviation angle range comprising the minimum threshold deviation angle; and
limit the deviation angle control element to the threshold deviation angle range.
